(19) United States
(12) Patent Application Publication
(10) Pub. No.: US 2014/0153090 A1
(43) Pub. Date: Jun. 5, 2014

(54) PROJECTION SYSTEM

(71) Applicants: Takashi Takenouchi, Atsugi-shi (JP); Fumio Karasawa, Tokyo (JP); Toru Sasaki, Tokyo (JP)

(72) Inventors: Takashi Takenouchi, Atsugi-shi (JP); Fumio Karasawa, Tokyo (JP); Toru Sasaki, Tokyo (JP)

(21) Appl. No.: 14/239,207

(22) PCT Filed: Aug. 22, 2012
(86) PCT No.: PCT/US12/51838

§ 371 Date: Feb. 17, 2014

(30) Foreign Application Priority Data
Aug. 24, 2011 (JP) 2011-182854

(51) Int. Cl. G03B 21/62

(52) U.S. Cl. CPC G03B 21/62
USPC 359/453; 359/454

(57) ABSTRACT

The present application provides a projection system by which constraints placed on space use of a user can be reduced. The projection system includes: a projector and a screen. The screen includes a first film for transmitting image light incoming from the projector and a second film for transmitting the image light transmitted through the first film. A pattern for refracting or reflecting the image light toward the second film is formed on a light entrance face of the first film receiving the image light. The incident angle of the image light entering the first film is not less than 20 degrees.

### FIELD OF THE INVENTION

An aspect of the present invention is related to a projection system.

### BACKGROUND

Conventionally, rear projection systems in which image light is projected from behind a screen are known. For example, Japanese Publication Number 2004-533636 describes a method for displaying information to an audience using a rear projection system. This method includes a step of providing a projector that can present an image and a step of providing a flexible screen having a rear face that receives light from the projector and a display face on a side opposite the rear face.

### SUMMARY OF THE INVENTION

With conventional rear projection systems such as that described in Japanese Publication Number 2004-533636, it is necessary to place the projector a certain distance from the screen. As a result, what is called “dead space” is created in the space between the projector and the screen, and space usable by a user is diminished an equivalent amount. Therefore, there is a need for a projection system by which constraints placed on space use of a user can be reduced.

A projection system according to an embodiment of the present invention includes a projector and a screen which includes a first film for transmitting image light incoming from the projector, and a second film for transmitting the image light transmitted through the first film. A pattern for refracting or reflecting the image light toward the second film is formed on a light entrance face of the first film receiving the image light, and an incident angle of the image light entering the first film is not less than 20 degrees.

According to such an embodiment, the incident angle of the image light incoming from the projector is not less than 20 degrees and, therefore, the projector is placed that much closer to the screen. As a result, an equivalent amount of dead space is eliminated and constraints placed on space use of a user can be reduced.

In a projection system according to another embodiment, the pattern may be a substantially concentric circular pattern formed by a plurality of prismatic concavoconvex patterns.

In a projection system according to yet another embodiment, the incident angle of the image light entering the first film may be not less than 25 degrees.

In a projection system according to yet another embodiment, the incident angle of the image light entering the second film may be less than 20 degrees.

In a projection system according to yet another embodiment, the incident angle of the image light entering the second film may be not more than 15 degrees.

In a projection system according to yet another embodiment, a bead layer may be coated on the light entrance face of the second film receiving the image light.

In a projection system according to yet another embodiment, a light absorption layer may be formed on an inner side of the bead layer.

In a projection system according to yet another embodiment, the first film and the second film may face each other across an intermediate layer having a refraction index of less than 1.3.

In a projection system according to yet another embodiment, an edge of the first film and an edge of the second film are laminated via a bonding layer, and the intermediate layer may be an air layer.

According to an aspect of the present invention, a projection system can be provided by which constraints placed on space use of a user can be reduced.

### BRIEF DESCRIPTION OF THE DRAWINGS

FIG. 1 is a perspective view schematically illustrating a projection system according to an embodiment.

FIG. 2 is a cross-sectional view taken along line II-II of an example of the screen depicted in FIG. 1.

FIG. 3 is a drawing illustrating a prismatic pattern.

FIG. 4 is a drawing illustrating a concentric circular pattern.

FIG. 5 is a drawing illustrating a pseudo-concentric circular pattern.

FIG. 6 is a magnified view of a die for forming the pattern depicted in FIG. 5.

FIG. 7 is a cross-sectional view taken along line II-II of another example of the screen depicted in FIG. 1.

FIG. 8 is a drawing that describes an incident angle of image light to the screen.

FIG. 9 is a graph showing a relationship between the incident angle of the image light to the screen and luminance.

### DETAILED DESCRIPTION

An embodiment of the present invention is described below in detail while referring to the accompanying drawings. Note that in the descriptions of the drawings, similar or identical components are assigned identical reference numbers and duplicate descriptions thereof are omitted.

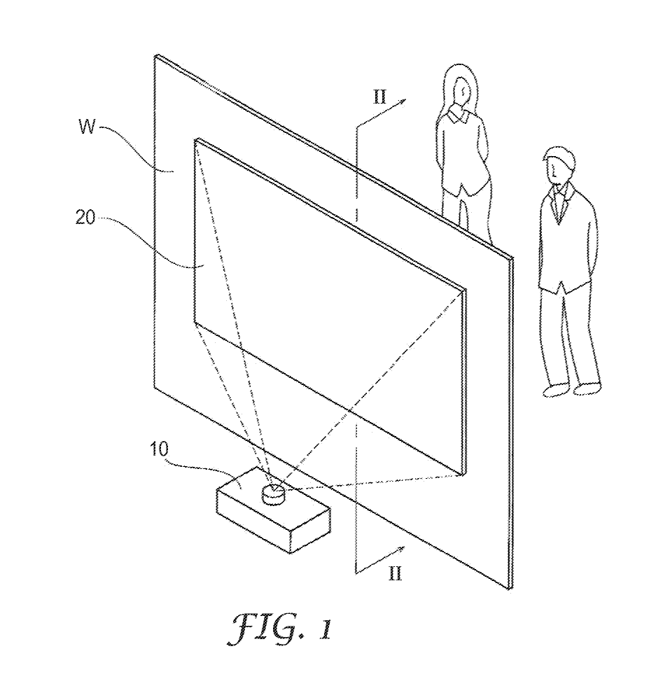

A projection system 1 according to an embodiment is a rear projection system that projects image light from a rear face of a screen. As illustrated in FIG. 1, the projection system 1 includes a projector 10 and a screen 20. The screen 20 is laminated on a glass window, a transparent acrylic board, or the like. Note that in the example illustrated in FIG. 1, the rectangular screen 20 is depicted laminated on a window W, but the shape of the screen 20 and the placement location of the projection system 1 can be selected as desired. For example, an embodiment in which a projection system using a human-shaped screen set up on the floor is possible.

The projector 10 is a device that outputs the image light to be projected on the screen 20. For example, an ultra-short focal length projector can be used as the projector 10. The projector 10 converts an image signal input from an information processor such as a personal computer (PC) or the like to image light, and outputs that image light from a light source. The projected image output as the image light may be a still image or a moving image.

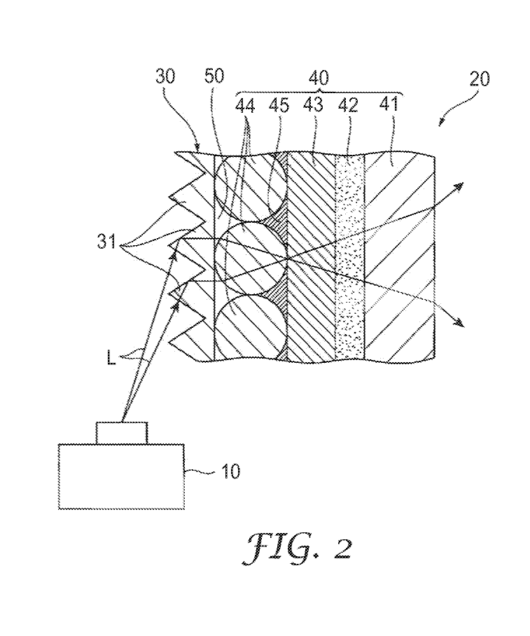

The screen 20 is a flat device for displaying the image light emitted from the projector 10. The screen 20 receives the image light emitted from the light source of the projector 10 directly on the rear face thereof, and transmits the image light toward a display face, which is a side opposite the rear face. As illustrated in FIG. 2, the screen 20 is provided with a first film 30 that functions as the rear face and a second film 40 that is laminated on the first film 30 and functions as the display face. Note that as necessary, the image light is shown as “L” in FIG. 2 and onward.

The first film 30 is a light transmitting film (turning film) that receives the image light from the projector 10 and refracts or reflects that image light toward the second film 40. A pattern 31 is formed on the light entrance face (light receiving face) of the first film 30, which is the rear face of the screen 20, for refracting or reflecting the image light toward the second film 40. The pattern 31 is a concavoconvex pattern in which mountain-like fine convex portions having edge lines are arranged.

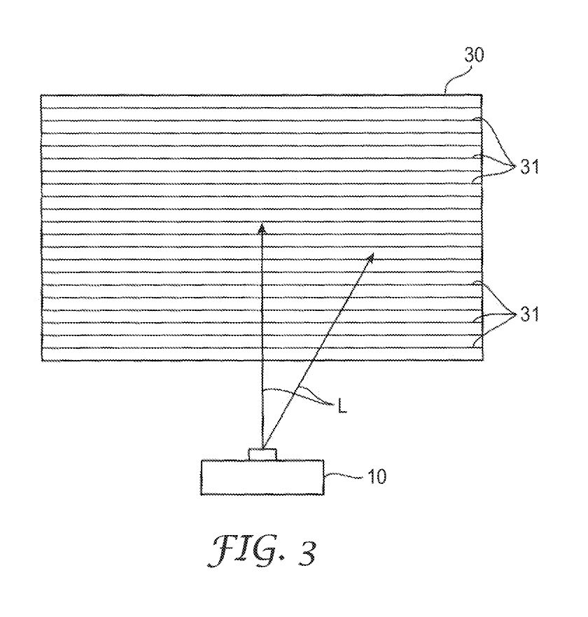

The form of the pattern 31 is not limited. For example, as illustrated in FIG. 3, the pattern 31 may be a prismatic pattern (hereinafter referred to as “prism pattern”) or a Fresnel lens-like pattern. When the pattern 31 is a prism pattern, the image light from the projector 10 reflects and then travels toward the second film 40. When the pattern 31 is a Fresnel lens-like pattern, the image light refracts within the pattern and then travels toward the second film 40. As illustrated in FIG. 3, when the pattern 31 is a prism pattern or a Fresnel lens-like pattern, the first film 30 is disposed with respect to the projector 10 so that the edge lines of the pattern intersect the light path of the image light.

The prism pattern can be configured as a pattern in which a plurality of collapsed triangular poles is arranged in a uniform direction. Additionally, the prism pattern can be configured as a pattern in which mountain-like convex portions having linear edge lines are arranged in a uniform direction. Alternatively, the prism pattern can be configured as a pattern in which “V” shaped grooves extending along a uniform direction are arranged in a uniform direction.

Prism patterns and Fresnel lens-like patterns can be fabricated easily and inexpensively. However, in these cases, the incident angle of the image light to the inclined faces forming the pattern is non-uniform in the edge line direction of the pattern. Therefore, in cases where the screen 20 is large, partial darkening of the projected image occurs. More specifically, the farther the screen is placed from the light source along the edge line direction of the pattern (a position where the incident angle is larger), the more the luminance of the projected image declines.

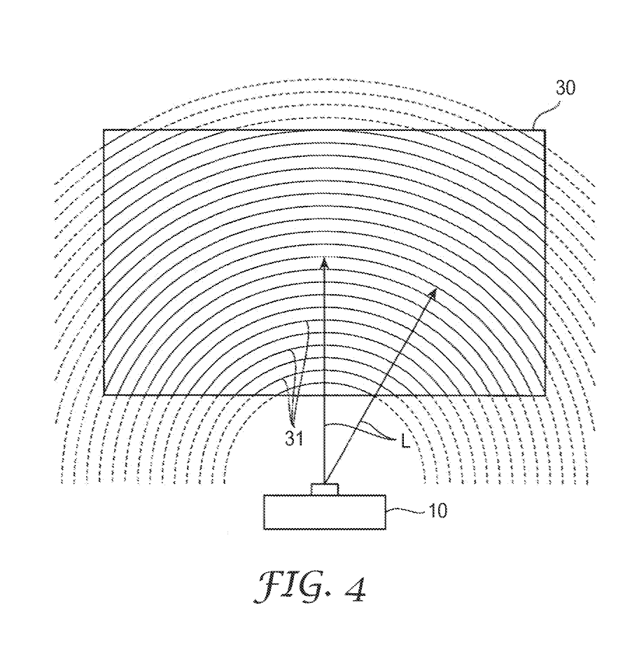

As illustrated in FIG. 4, the pattern 31 may be a pattern in which mountain-like convex portions having semicircular edge lines are arranged in a concentric circular manner. In this case, the first film 30 is positioned so that the center of the concentric circle is close to the position of the projector 10.

When using a concentric circular pattern, the incident angle of the image light to the inclined faces forming the pattern is uniform throughout the entire screen 20. Therefore, luminance of the projected image at or above a certain level can be maintained through the entire screen 20. However, manufacturing costs must be taken into consideration because a concentric circular pattern must be fabricated specific to the dimensions of the screen 20 for which it will be used.

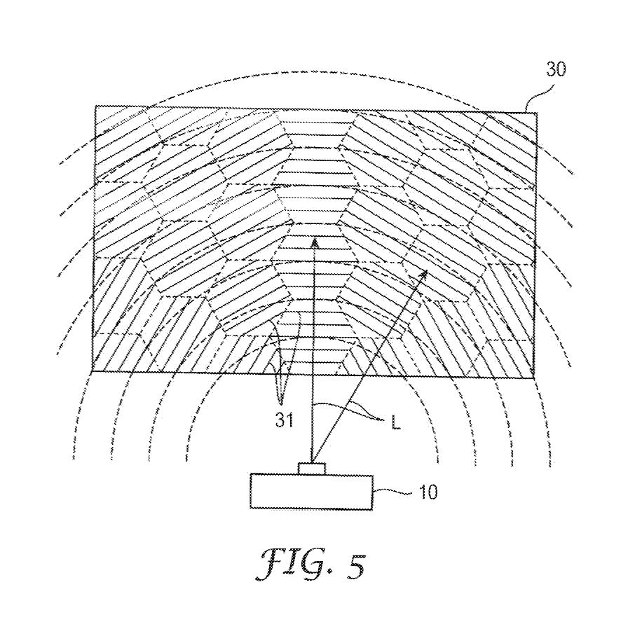

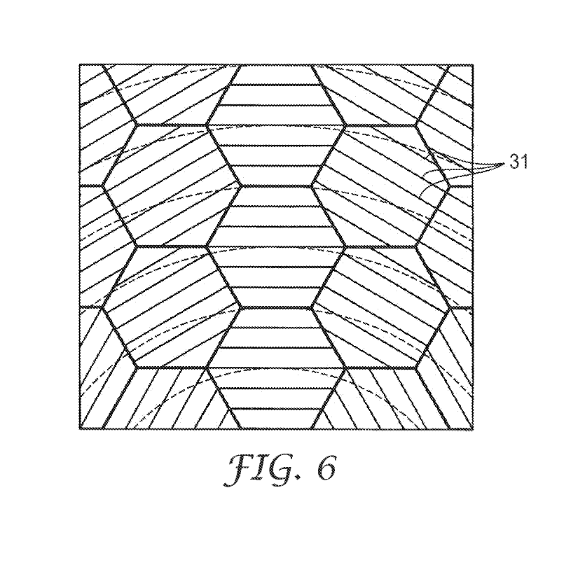

As illustrated in FIG. 5, the pattern 31 may be formed from a plurality of prism patterns arranged so as to form a pseudo-concentric circular shape. As illustrated in FIG. 6, such a pattern 31 is formed by: first forming a die by arranging regular polygonal (e.g. equilateral hexagonal) tiles, in which the prism pattern is formed, so as to form a pseudo-concentric circular edge line; and then forming the pseudo-circular pattern 31 on a light transmitting film via a micro-replication technique using this die.

When using the pseudo-circular pattern 31, the incident angle of the image light to the inclined faces forming the pattern is substantially uniform throughout the entire screen 20. Therefore, luminance of the projected image at or above a certain level can be maintained through the entire screen 20, the same as when using the concentric circular pattern. Additionally, because the only requirement is that the prism pattern be formed on the tiles, the tiles can be fabricated easily and inexpensively and, moreover, it is possible to use the tiles in the manufacture of various sizes of the screen 20. Therefore, manufacturing costs can be controlled.

The second film 40 is a light transmitting film that receives image light that enters from the first film 30 on a rear face thereof, and outputs the image light from the rear face to the display face, which is the side opposite the rear face. In this embodiment, a rear projection film (RPF) manufactured by 3M Company (e.g. 3MTMRPF120) is used as the second film. As illustrated in FIG. 2, the second film 40 (RPF) includes a transparent substrate 41, a bonding agent 42, a transparent polyvinyl chloride (PVC) film 43, a bead layer 44, and a light absorption layer (light blocking layer) 45.

A first face of the transparent substrate 41 functions as the display face of the screen 20, and the PVC film 43 is adhered to a second face (side opposite the first face) of the transparent substrate 41 using the bonding agent 42. The bead layer 44 is coated on a face of the PVC film 43, which corresponds with the rear face (light entrance face of the image light) of the second film 40. Space between the PVC film 43 and the bead layer 44 or, in other words, the inner side of the bead layer 44, is filled with the light absorption layer (light blocking layer) 45, which is formed from black polyvinyl chloride. The light absorption layer 45 blocks ambient light from entering and, thus, serves to increase the contrast of the image light. Glass beads and beads formed from acrylic resins such as PMMA (polymethyl methacrylate) and the like can be used for the bead layer 44.

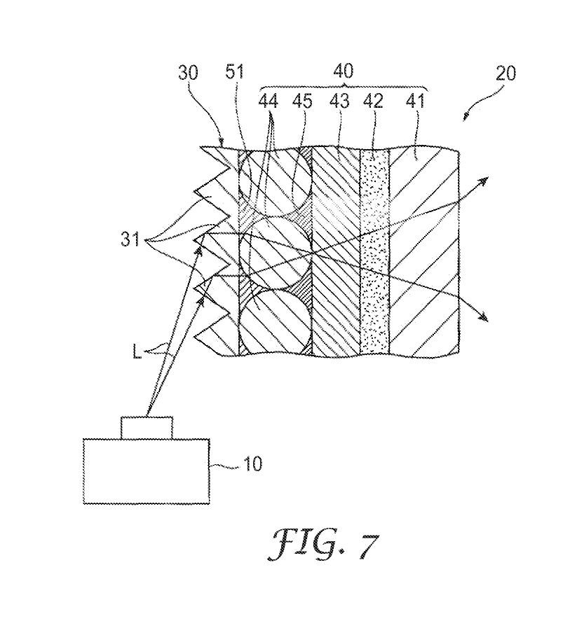

The first film 30 and the second film 40 are bonded together via a bonding layer. A method for bonding these two films can be selected as desired and, therefore, the bonding layer is not limited to a single configuration. For example, the first film 30 and the second film 40 may be bonded via a bonding agent or adhesive tape applied to the edges of each of the films. In this case, as illustrated in FIG. 2, an air layer 50 occupies regions between the first film 30 and the second film 40 other than the edges and, therefore, a refraction index between the first film 30 and the second film 40 is 1.0. Alternately, as illustrated in FIG. 7, these films may be bonded together by filling the space between the first film 30 and the second film 40 with a bonding agent 51 having a refraction index of less than 1.3. In either case, the first film 30 and the second film 40 are arranged so as to face each other via an intermediate layer 50 or 51 having a refraction index of less than 1.3.

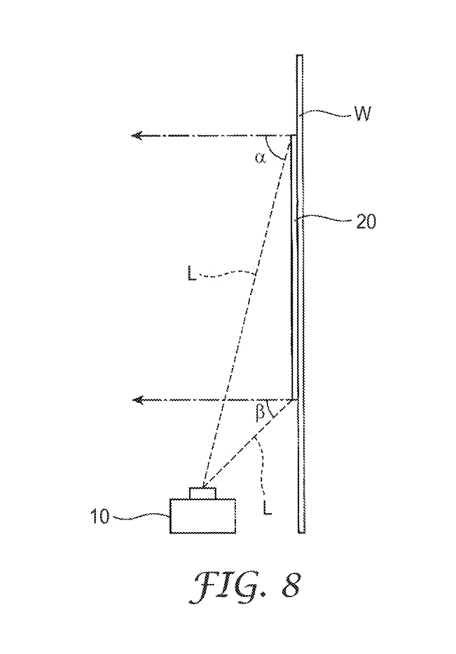

The projector 10 and the screen 20 are positioned such that the incident angle of the image light emitted from the projector 10 on the first film 30 is not less than 20 degrees or not less than 25 degrees. Here “incident angle” refers to the angle formed between a line normal to the light entrance face and the light path of the incident light. In the example illustrated in FIG. 8, the incident angle is indicated as “α” at the top end of the screen 20, which is the end that is far from the projector 10, and is indicated as “β” at the lower end of the screen 20, which is the end that is close to the projector 10. Therefore, a range of the incident angle θ is β≦θ≦α, and the incident angle θ is not less than 20 degrees or not less than 25 degrees in part or all of the range from the lower limit β to the upper limit α. If the projector 10 is an ultra-short focal length projector, the projector 10 can be placed very close to the screen 20 along an axis of a line normal to the display face of the screen 20. The closer the projector 10 is placed to the screen 20, the larger the incident angle θ will become.

The image light that enters the screen 20 at the incident angle θ described above refracts or reflects at the pattern 31 formed on the light entrance face of the first film 30 and proceeds toward the second film 40. Here, the incident angle of the image light that enters the second film 40 from the first film 30 is less than 20 degrees or is not greater than 15 degrees. Therefore, the pattern 31 is formed so as to input the image light, which enters the first film 30 at an incident angle of not greater than 20 degrees or not greater than 25 degrees, to the second film 40 at an incident angle of less than 20 degrees or not greater than 15 degrees. The image light can be refracted or reflected as described above by adjusting a bottom angle of the convex portions forming the pattern 31.

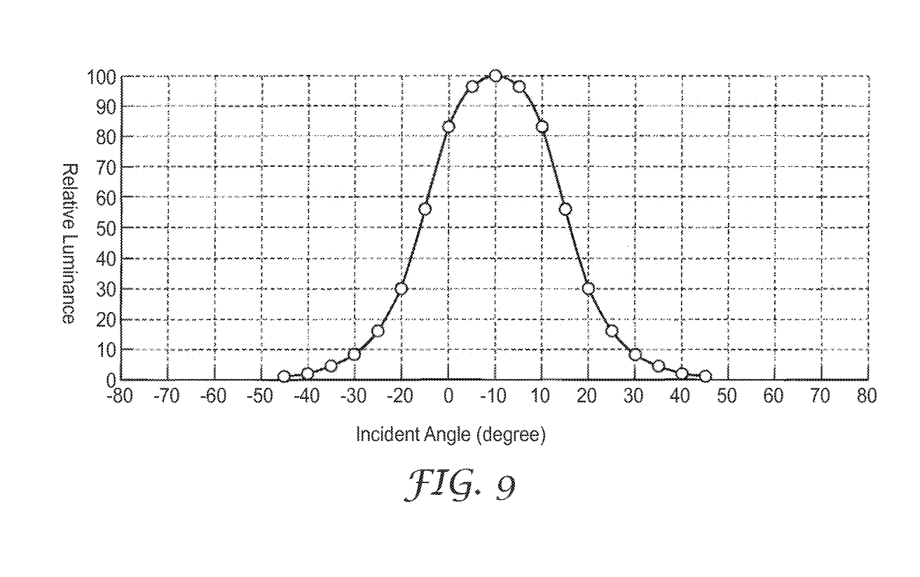

When RPF is used as the second film 40 as in this embodiment, it will not be possible to ensure a level of luminance sufficient to enable image viewing by a viewer due to the bead layer 44 and the light absorption layer 45 if the incident angle is 20 degrees or greater. This is because a large proportion of the image light will be absorbed by the light absorption layer 45 if the incident angle is 20 degrees or greater. If configured such that the luminance is 100 when the incident angle of the image light is 0 degrees, which is most ideal, as illustrated in FIG. 9, relative luminance exceeding 50 can be ensured when the incident angle is within ±15 degrees, and a relative luminance of 30 or greater, which is a level at which images are visible to a viewer, can be ensured when the incident angle is within ±20 degrees. Therefore, the incident angle of the image light on the second film 40 may be less than 20 degrees, or may be 15 degrees or less.

As described above, according to this embodiment, the incident angle of the image light incoming from the projector 10 is not less than 20 degrees and, therefore, the projector 10 is placed much closer to the screen 20. As a result, an equivalent amount of dead space is eliminated and constraints placed on space use of a user can be reduced. This means that existing space can be used in a useful manner by a user even in cases where the projection system 1 is introduced. For example, if an ultra-short focal length projector is positioned on a floor or ceiling in a state proximal to the screen along an axis of a line normal to the display face of the screen, dead space can be substantially completely eliminated.

Additionally, according to this embodiment, the incident angle of the image light entering the second film 40 from the first film 30 is less than 20 degrees. Therefore, the luminance of the image light projected on the display face of the screen 20 can be maintained at or above a certain level (relative luminance of 30 or greater shown in FIG. 9). If the light absorption layer 45 is used as in this embodiment, the contrast of the image will increase and, therefore, a sharp image can be displayed on the screen 20 even in cases where luminance is comparatively low.

The present invention has been described in detail based on the embodiment. However, the present invention is not limited to the embodiment described above. Various modifications can be made to the present invention without deviating from the scope thereof.

In the embodiment described above, the second film 40 includes the bead layer 44 and the light absorption layer 45, but these layers are not essential components. Moreover the type of light transmitting film used as the second film 40 is not limited. In such a case, a sharp and bright image can be displayed to a viewer by adjusting the incident angle of the image light projected on the second film 40 to be less than 20 degrees or 15 degrees or less.

The refraction index of the intermediate layer sandwiched between the first film 30 and the second film 40 may be a value that is close to about 1.3. For example, in cases where the space between the first film 30 and the second film 40 is filled with an acrylic bonding agent, the refraction index of the intermediate layer will be from about 1.4 to about 1.5. Additionally, in cases where the space between the films 30 and 40 is filled with water, the refraction index of the intermediate layer will be about 1.33.

1. A projection system comprising: a projector and
a screen which comprises a first film for transmitting image light incoming from the projector, and a second film for transmitting the image light transmitted through the first film,
wherein
a pattern for refracting or reflecting the image light toward the second film is formed on a light entrance face of the first film receiving the image light, and
an incident angle of the image light entering the first film is not less than 20 degrees.

2. The projection system according to claim 1, wherein the pattern is a substantially concentric circular pattern formed by a plurality of prismatic concavoconvex patterns.

3. The projection system according to claim 1, wherein the incident angle of the image light entering the first film is not less than 25 degrees.

4. The projection system according to claim 1, wherein the incident angle of the image light entering the second film is less than 20 degrees.

5. The projection system according to claim 4, wherein the incident angle of the image light entering the second film is not more than 15 degrees.

6. The projection system according to claim 1, wherein a bead layer is coated on the light entrance face of the second film receiving the image light.

7. The projection system according to claim 6, wherein a light absorption layer is formed on an inner side of the bead layer.

8. The projection system according to claim 1, wherein the first film and the second film face each other across an intermediate layer having a refraction index of less than 1.3.

9. The projection system according to claim 8, wherein an edge of the first film and an edge of the second film are laminated via a bonding layer, and the intermediate layer is an air layer.
